(19) United States
(12) Patent Application Publication
(10) Pub. No.: US 2013/0042530 A1
(43) Pub. Date: Feb. 21, 2013

(54) Beam Protection System for a Door Operator

(71) Applicants: Jack Leivenzon, Blackburn (AU); Paul Salter, Skye (AU); Glenn Edward Fleming, Berwick (AU)

(72) Inventors: Jack Leivenzon, Blackburn (AU); Paul Salter, Skye (AU); Glenn Edward Fleming, Berwick (AU)

(73) Assignee: SMART OPENERS PTY LTD, Blackburn, VI (AU)

(21) Appl. No.: 13/574,432

(22) PCT Filed: Jan. 21, 2011
(86) PCT No.: PCT/AU2011/000063

§ 371 Date: Oct. 15, 2012

(30) Foreign Application Priority Data
Jan. 22, 2010 (AU) 2010900248

(51) Int. Cl. E05F 15/20

(52) U.S. Cl. 49/26; 49/28

(57) ABSTRACT

A obstruction beam protection system for sensing an object in the path of the door during closing of the door by a door operator and for inhibiting operation for closing of the door. The beam protection system comprises a beam transmitter and beam receiver for positioning proximate to a passageway to be closed by the door, so as, when in use, to project a beam from the beam transmitter across the passageway to be receivable by the beam receiver. The beam transmitter and the beam receiver are provided with a local communication system for communication with an operator communication system associated with the operator. The beam transmitter and the beam receiver are both adapted to operate in a low power sleep state and a wake state. In the wake state the beam transmitter will transmit a beam across the passageway to be receivable by said beam receiver and so said beam receiver will be able to process a received beam as an indication of an object not being in the path of the door, the absence or interruption of a received beam as an indication of an object being in the path of the door. This later condition of absence or interruption can be communicated via the local communication system to the operator communication system to inhibit said operator from closing said door by appropriate operation of the operator electric control circuitry.

This invention relates to a beam protection system for a door operator for sensing an object in the path of the door during closing of the door by the operator and for inhibiting operation for closing of the door. This invention has application as a purpose built door operator incorporating a beam protection system, or as a retro-fit beam protection system for known door operators.

Hitherto, door operators have been known for opening and closing doors to passageways such as in garages or the like. Some installations are domestic whilst others are industrial. The present invention has applications in all such environments. Known operators have incorporated beam sensing systems that project a beam from a beam transmitter across a door passageway towards a beam receiver. Some systems are photoelectric visible light system, while others are infrared systems and others may be laser systems. A beam transmitter and a beam receiver are hard wired with the door operator control circuitry and are permanently powered by power supplied by the door operator itself. Because the beam transmitter and the beam receiver are hard wired it usually necessary to cut trenches in concrete driveways or the like for receipt of the power leads. This, in turn, requires expensive cutting of trenches in the concrete driveway, and the subsequent problem of filling the trenches once the wires have been laid. In addition, because the beam transmitter and the beam receiver are permanently ON there is a residual current drawn which leads to greenhouse gas emissions and unwanted side effects. Typically, the beam transmitter and the beam receiver are situated immediately adjacent the passageway closed by the door so that if an object is under the door during closing, the beam transmitted from the beam transmitter to the beam receiver will be interrupted and the absence of the beam will cause the door operator to cease operation. The object under the door may be a child or other person or may be other physical obstructions such as bicycles, toys or the like or even another motor vehicle.

Whilst the known beam protection systems are reliable they have the inherent problems mentioned above.

It is therefore desirable to provide an alternative beam protection system where one or more of the above problems are minimised.

Therefore, in accordance with a first broad aspect of the present invention there is provided a door operator with an obstruction beam protection system for sensing an object in the path of the door during closing of the door by the operator and for inhibiting operation for closing of the door,

said beam protection system comprising a beam transmitter and beam receiver for positioning proximate to a passageway to be closed by the door, so as, when in use, to project a beam from the beam transmitter across the passageway to be receivable by the beam receiver, the beam transmitter and the beam receiver being provided with a local communication system for communication with an operator communication system associated with the operator,

the beam transmitter and the beam receiver both adapted to operate in a low power “sleep” state and a “wake” state, so that in the “wake” state the beam transmitter will transmit a beam across the passageway to be receivable by said beam receiver and so said beam receiver will be able to process a received beam as an indication of an object not being in the path of the door, and the absence or interruption of a received beam as an indication of an object being in the path of the door and in this later condition of absence or interruption, communicate via the local communication system to the operator communication system to inhibit said operator from closing said door by appropriate operation of the operator electric control circuitry.

In an embodiment the operator has electric control circuitry configure to in response to an instruction initiated by a user being provided to close the door from an open position said operator communication system will communicate with the local communication system so the communication will be processed by respective circuitry in the beam transmitter and the beam receiver to change the beam transmitter and the beam receiver from a “sleep” state to a “wake” state, if they are not already in the “wake” state.

In another embodiment at least one of the beam transmitter and the beam receiver is adapted to periodically change from a “sleep” state to a “wake” state and communication with the operator communication system to determine whether the operator is instructed to close the door from an open position to a closed position and if the operator is instructed to close the door the beam transmitter will transmit the beam receivable by the beam receiver.

In an embodiment the beam transmitter and beam receiver are further configured to identify fault conditions for any one or both of the beam transmitter an beam receiver and when a fault condition is detected communicate via the local communication system to indicate the fault condition to the operator whereby the operator can inhibit operating the door. For example, fault conditions can include any one or more of: misalignment of the beam transmitted between the beam transmitter and beam receiver; damage to the beam transmitter; damage to the beam receiver; fault condition in the beam transmitter; and fault condition in the beam receiver.

In an embodiment, said operator electric control circuitry has a timer to be activated on receipt of a communication from said beam receiver local communication system to initiate an inhibited operation of said door, after a suitable time, to provide a communication via the operator communication system to the local communication system of the beam transmitter and the beam receiver to change their states from a “wake” state to a “sleep” state.

In an embodiment the local communication system in both of the beam transmitter and the beam receiver are configured to communicate with the operator communication system upon changing state from a “sleep” state to a “wake” state to confirm they have changed state to a “wake” state, and wherein the control circuit is configured in the absence of a communication establishing both the beam transmitter and the beam receiver are in a “wake” state, to inhibit operation of the operator to close the door.

In one manner of installation the beam transmitter and beam receiver can be positioned such that a beam projected by the beam transmitter is projected across the passageway toward the beam receiver to be receivable by the beam receiver.

In an alternative manner of installation the beam transmitter and beam receiver can be positioned such that a beam projected by the beam transmitter across the passageway is reflected off an object across the passageway toward the beam receiver to be receivable by the beam receiver.

In accordance with a first broad aspect of the present invention there is provided an obstruction beam protection system configured for operation with a door operator to sense an object in the path of the door during closing of the door by the operator and signalling the door operator to inhibit operation for closing of the door, the beam protection system comprising

a beam transmitter and beam receiver for positioning proximate to a passageway to be closed by the door operated by the operator, so as, when in use, to project a beam from the beam transmitter across the passageway to be receivable by the beam receiver, the beam transmitter and the beam receiver being provided with a local communication system for communication with an operator communication system associated with the operator,

the beam transmitter and the beam receiver both adapted to operate in a low power “sleep” state and a “wake” state, so that in the “wake” state the beam transmitter will transmit a beam across the passageway to be receivable by said beam receiver and so said beam receiver will be able to process a received beam as an indication of an object not being in the path of the door, and the absence or interruption of a received beam as an indication of an object being in the path of the door and in this later condition of absence or interruption, communicate via the local communication system to the operator communication system to inhibit said operator from closing said door by appropriate operation of the operator electric control circuitry.

In order that the invention can be more clearly ascertained, an example of a preferred embodiment will now be described with reference to the accompanying drawings wherein:

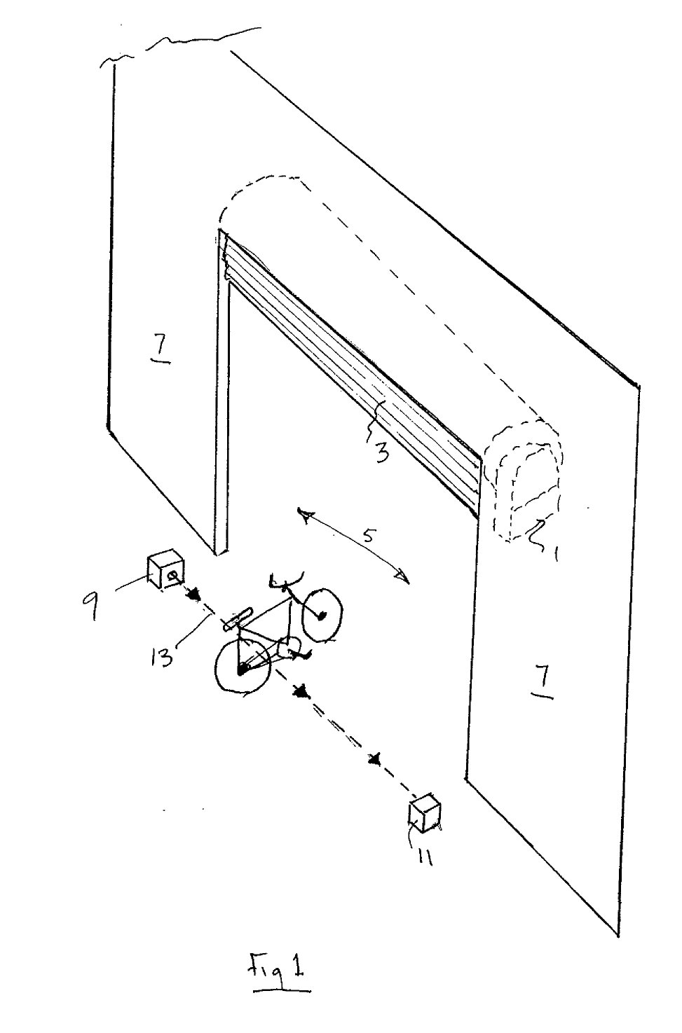

FIG. 1 shows a diagrammatic perspective view of a door operator connected with a roller shutter door and closing a passageway in a garage. The arrangement includes a beam transmitter and a beam receiver. The arrangement depicted represents both a known prior art arrangement and an arrangement according to an embodiment of the present invention.

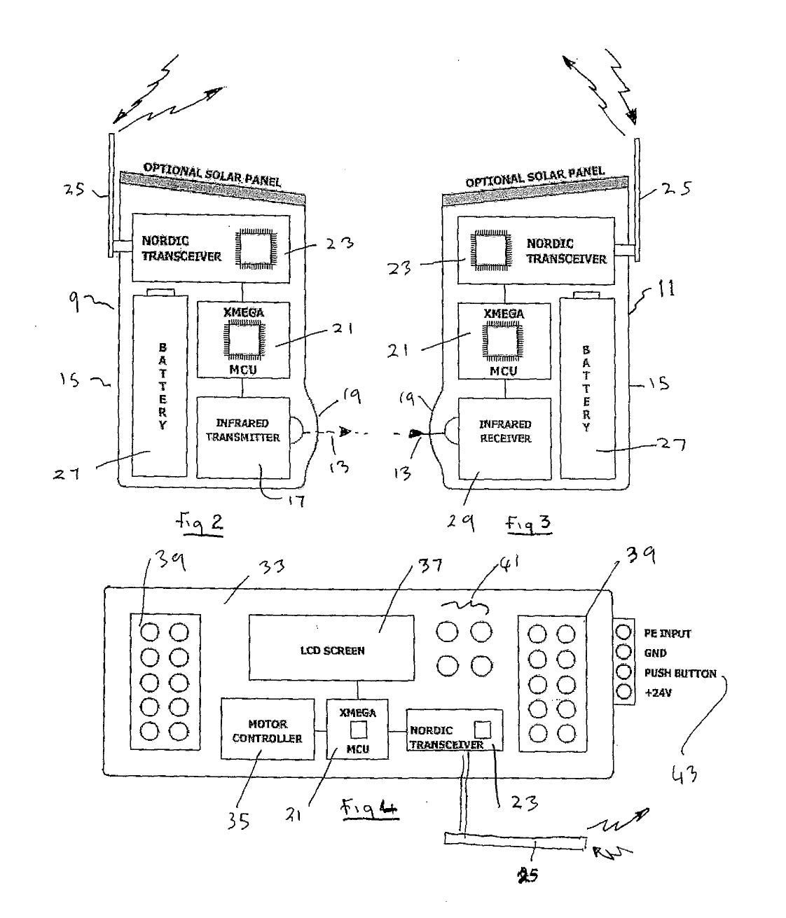

FIG. 2 is a diagrammatic view of components in a beam transmitter that include features of an embodiment of the present invention.

FIG. 3 is a view similar to FIG. 2, but of a beam receiver incorporating features of an embodiment of the present invention.

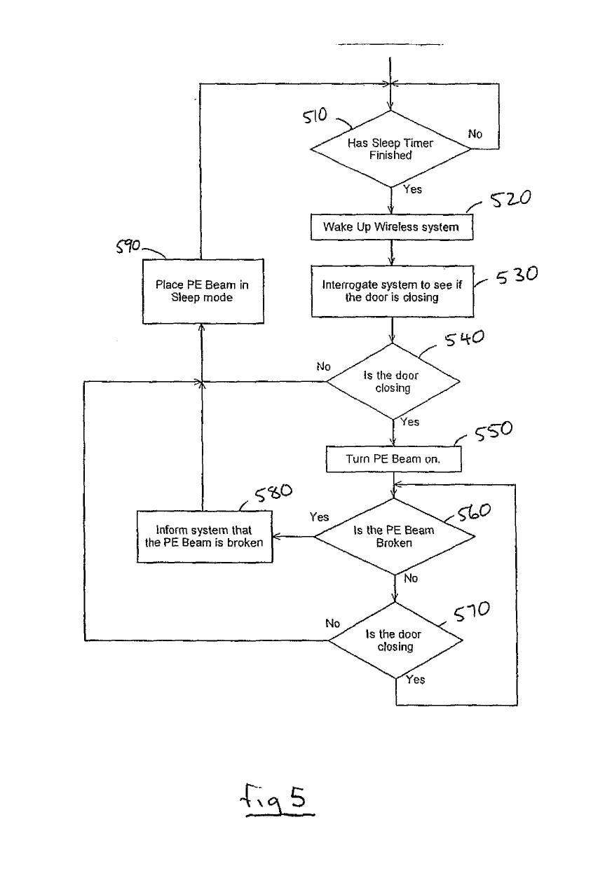

FIG. 4 is a block schematic view of an operator control circuit incorporating features of an embodiment of the present invention.

FIG. 5 is a functional flow diagram showing process steps used in the embodiment of the present invention.

Referring firstly to FIG. 1, there is shown a typical installation of a door operator with a beam transmitter and a beam receiver positioned across a passageway closed by a door, gate or like barrier. Here, the door operator 1 is a conventional door operator. A roller door curtain 3 is provided to close a passageway 5 in a front wall 7 of a garage or similar. The door may be a sectional door or tilt door or the like and is not to be limited to roller doors. Embodiments may also be applied where the passageway is closed by a sliding or swing gate, door or like barrier. A beam protection system is provided adjacent the passageway 5 and in proximity thereto. The beam protection system comprises a beam transmitter 9 and an aligned beam receiver 11. In the prior art the beam transmitter 9 and the beam receiver 11 physically connect with the door operator 1 via electric cables (not shown). Typically, electric cables need to be inserted into a concrete or similar driveway through the passageway 5. This requires trenches to be cut into the driveway for receipt of the cables. Once the cables are laid, the trenches need to be filled. Cutting of the trenches can be troublesome and expensive. Further, the filling of the trenches after the cables are laid can cause problems. If a silicon sealant is used, then the silicon material deteriorates with time which is undesirable. In addition, the cut trenches provide an unsightly appearance. In addition to the above problems, the beam transmitter 9 and the beam receiver 11 consume power for their operation which is usually continuous. Typically, the beam transmitter 9 and the beam receiver 11 are infrared units and therefore the beam 13 is generally non visible to the naked eye.

When the operator 1 is activated to close the door 3, interrogation is made to the beam receiver 11 to determine if the beam receiver is receiving the beam 13 from the beam transmitter 9. If the beam receiver 11 is not receiving the transmitted beam 13 then the operation of the operator 1 is inhibited for closing the door. If the door is moving in a closing mode and the beam 13 then interrupted, further movement of the door 3 is ceased or moved in the opposite direction to the fully open stop position. FIG. 1 shows an object such as a bicycle in the path of the door and obstructing the beam 13. Thus, the door curtain 3 will not be operated to close as otherwise it may damage the object and/or the door 3 and/or the operator 1.

In the embodiment of the present invention, the beam transmitter 9 and the beam receiver 11 are not permanently activated. The beam transmitter 9 and the beam receiver 11 are arranged with internal circuitry to assume a “sleep” state. The circuitry within the beam transmitter 9 and beam receiver 11 enable the beam transmitter 9 and the beam receiver 11 to assume a “wake” state (if they are not already in a “wake” state) at the time when the door operator 1 is activated to close the door 3. There is a communication system to communicate signals between the beam transmitter 9, beam receiver 11 and control circuitry within the door operator 1. This communication is a duplex communication process as will be described hereinafter. The beam transmitter 9 and beam receiver 11 are battery operated and the communication is a wireless communication (hard wired power and hard wired communication is included in the broader inventive concept herein). The battery powered and wireless communication version is the embodiment described in detail.

Referring now to FIG. 2, there is shown a block schematic diagram of the components within beam transmitter 9. Here, the beam transmitter 9 has an external case 15 of suitable material such as UV resistant plastics. A transmitter 17 is provided in the case 15. In this example, the beam transmitter 17 is an infrared (IR) beam transmitter device. Case 15 has an IR transparent lens 19 so that IR from the IR beam transmitter 17 can be directed towards the beam receiver 11 as will be described hereinafter. Mounted within the case 15 is a microcontroller 21 which may comprise an ATMEL XMEGA microcontroller or similar. The microcontroller 21 is connected with the IR beam transmitter 17 and with a wireless transceiver chip 23 such as a Nordic chip or similar that operates in a suitable frequency range such as for example, 433 Megahertz, 950 Megahertz, or 2.4 Gigahertz. Other frequencies may be utilised. The microprocessor 21 performs protocol processing for the Nordic transceiver chip 23. For example the microprocessor can implement an ADS decryption/encryption protocol or similar networking code. In alternative embodiments the transceiver chip may include an ADS decryption/encryption protocol or similar networking code, alleviating the need for this processing functionality in the microprocessor 21. The transceiver 23, in turn, connects with an aerial 25. Electronic components within the housing 15 are powered from a suitable battery such as a rechargeable nickel hydrate battery 27. The transceiver 23 is bi directional and therefore able to transmit signals and receive signals in a duplex arrangement.

Beam receiver 11 is provided with a similar case 15 to that in the beam transmitter 9. The case 15 contains a beam receiver 29 which is matched with the beam transmitter type. Thus, the beam receiver 29 is an IR beam receiver. Case 15 includes a similar lens 19 to focus the IR beam onto the infrared receiver 29. In some installations, the lens may not be provided, but rather a clear transparent covering may be provided over the transmitter 17 and receiver 29 relevant regions. Receiver 11 includes a similar microprocessor 21 and battery 27 to that in the beam transmitter 9. A similar transceiver 23 and antenna 25 to than in the beam transmitter 9 may also be provided to enable communication directly between the beam receiver 11 and the operator 1. In some embodiments the beam receiver may only communicate with the beam transmitter via the infrared interface which may be an IR transceiver rather than a receiver 29 as shown. An optional solar panel 31 may be provided on both the beam transmitter 9 and the beam receiver 11 for charging of the batteries 27.

In the embodiment shown both the beam transmitter 9 the beam receiver 11 are provided with a transceiver 23 for communication with the operator. By using a two way (duplex) wireless communication with the operator, the transceiver 23 and the microcontroller 21 may be signalled from the operator to change state from a “sleep” state to a “wake” state, and to acknowledge the change of state to the operator 1. This will be described in detail hereinafter. The transceivers 23 can be powered DOWN when not transmitting any data, and can be powered UP once there is a detection of an incoming signal. In this way, the transceiver and the microcontroller circuitry in transmitter 9 and the beam receiver 11 can be in an idle low power “sleep” state without consumption of significant battery power or even power from a mains supply if the transmitter 9 and receiver 11 are permanently powered from the mains power.

FIG. 4 shows a block schematic arrangement of the components in the operator 1. Here, there is provided a circuit board 33 that contains a motor controller circuit 35 of known type. The motor control circuit 35 is, in turn, connected with a further microprocessor of the same type previously referred to as the microcontroller 21 in the beam transmitter 9 and beam receiver 11. The controller 21, in turn, connects with a transceiver 23 of the same type previously referred to in the beam transmitter 9 and beam receiver 11. The controller 21 also connects with an LCD screen 37 that permit the user to view various displays thereon for setting parameters of operation of the operator 1. In another example, the LCD screen 37 may alternatively connect directly with the controller in the motor control circuit 35. The circuit board 33 includes a series of LED lights 39 for providing safety illumination within the garage area or other area closed by the door 3. A series of manual operator buttons 41 are also provided to permit direct control of operation of the operator at the operator itself. The motor control circuit 35 can be operated directly by the push buttons 41, or via a remote radio controller in a known manner. The push buttons 41 enable setting of datums and other parameters relating to the particular door environment through a suitable control program within the motor controller 35. The circuit board 33 also includes a push button 43 for permitting operation of the operator 1 to open and/or close the door. Each time the push button 43 is operated, the door will caused to travel in the opposite direction. This is a known arrangement for operators.

Accordingly, if the door is to be opened and closed by operation of push button 43, or by a remote radio transmitter device that provides a similar function, then the motor controller 35 is activated. This, in turn, sends an instruction signal through the microcontroller 21 to, in turn, provide a signal to the transceiver 23. The transceiver 23 is connected with an aerial 25 so that a signal will be transmitted from the circuit board 33 to both the beam transmitter 9 and the beam receiver 11. This signal will be received by the respective transceivers 23 and processed by the microcontrollers 21 therein to cause the microcontrollers to change from a “sleep” state to a “wake” state. As the transceivers 23 can have a similar low power “sleep” state they will also be wakened once there is detection of an incoming radio signal. Under such conditions, a routine within the microcontrollers 21 causes a signal to be transmitted from both the beam transmitter 9 and the beam receiver 11 back to the operator for receipt by the transceivers 23 therein. This, in turn, instructs the microcontroller 21 in the operator that, the beam transmitter 9 and the beam receiver 11 have, in fact, been woken from their “sleep” states and are ready to monitor for interruption of the beam 13 across the passageway 5. If the beam 13 is not interrupted, then the door curtain 13 will close fully. If there is an object or obstruction interrupting the beam 13, then the door curtain 13 will either be inhibited from moving, or alternatively, if moving, will stop moving once the interruption is detected. The operator 1 may also reverse the direction of travel so that the door curtain 13 is returned to a fully open position for safety if the interruption is detected.

If the transceiver 23 in circuit board 33 does not receive a response from the beam transmitter 9 or beam receiver 11 following sending of a signal to change the state to a “wake” state within a short time, then the door will not operate to close.

If a signal indicating both the beam transmitter and beam receiver are awake and no obstruction is detected, the door 3 is then closed by the operator 1. The logic in the microcontroller 21 will then cause a signal to be sent back to the transceivers 23 in the beam transmitter 9 and beam receiver 11 to instruct them to change state to a “sleep” state.

In some embodiments the beam transmitter 9 and beam receiver 11 may be adapted to automatically perform internal diagnostic tests after a change to a “wake” state. The diagnostic tests identify fault conditions or damage to the beam transmitter or beam receiver or misalignment between the beam transmitted between the beam transmitter or beam receiver. The local communication system can be used to transmit a signal to the operator informing of any potentially problematic condition so operation of the door can be inhibited until the problem is fixed. In some embodiments the operator may be adapted to alert the user to a problem, for example by displaying a message in an operator display or remote transmitter unit, or flashing an error warning light. It should be appreciated that any means for providing feedback of errors or operation messages to a user or service centre may be utilised for notifying of an error with the beam transmitter and beam receiver.

Examples of fault conditions can include: a low battery condition, battery change warning, beam misalignment, low beam power, electronic faults, overheating, failure of device components, opening of housings, manual intervention, etc. Problems with low beam power may result from grime, dust or water effecting beam transmission and can be easily rectified by an operator is they are aware of the problem. Beam misalignment may occur if the beam transmitter or beam receiver are accidentally bumped or movement of the surface they are mounted on, for example as a result of concrete lifting, subsiding or cracking which can occur naturally. Notifying the user of such problems can enable them to correct these. Other faults such as electrical faults, overheating, device failure may require a service person to attend and fix the device. In some embodiments sensors can be provided to detect manual intervention, damage or tampering with the beam transmitter and beam receiver. Any detection of such manual handling of the devices can be reported to the user for investigation.

For safety purposes, if any potentially problematic condition is detected, at least the close operation of the door can be inhibited. In some cases the potentially problematic condition may be reported before complete failure of the beam system to minimise inconvenience to the user. For example, if the diagnostic tests are performed periodically, say once a day or once every six hours, then the potentially problematic condition may be reported before use of the door is required. The potentially problematic condition can then be investigated and any necessary corrective action taken before the door is used, or at least the user will know in advance that there is a problem and manual override operation will be required.

In one example, the beam transmitter 9 and the beam receiver 11 can be turned ON for both a closing and an opening mode of operation. In this arrangement, during an opening motion of the door 3, any interruption of the beam 13 can trigger an auto-close function to close the door 3 after a set time. This will allow passage of a vehicle from the garage, which will cause interruption of the beam 13, and then an auto closing function of the door 3 after the set time. In addition, multiple sets of beam transmitters 9 and beam receivers 11 may be provided on a network protocol so there can be added protection for inward and outward passage through gate or garage perimeters. For example, if the door curtain is instructed to be opened, and there is a remote swing gate or the like at a distant end of the property, that swing gate may also be opened. The arrangement may be such that it is not until after passage of a vehicle through the gate and a consequent interruption of the beam at the gate that the beam transmitter 9 and beam receiver 11 of the gate will cause closing of the gate and the door 3. A similar arrangement may be provided for a pedestrian door in the garage in the property in which the garage is located so that when a person passes through the door and the door 3 can be closed or locked.

Referring now to FIG. 5 there is shown a functional flow diagram for the circuit board 33 and microcontroller 21. Similar functional flow diagrams 5 apply for each of the microcontrollers 21 in the beam transmitter 9 and beam receiver 11. In this embodiment the beam transmitter 9 and beam receiver 11 are configured to periodically transition from a “sleep” state to a “wake” state and query the operator 1 as to the status of the door. At the expiration of a sleep timer 510 the transceiver 23 is woken 520 and a signal transmitted to the operator 530 to query whether or not the door is closing. If the operator 1 replies with a signal that it is not closing the door 540, then the transceiver 23 will be returned to a “sleep” state 590.

If the door is closing 550 then the infra red transmitter 17 and receiver 29 are turned on 550 to transmit a beam 13 across the passageway. If the beam is broken 560 then the operator 1 is informed 580 that the beam is broken so the movement of the door can be stopped. In some embodiments the operator may also change the direction of travel of the door so that the door opens a fully open condition for safely if an obstruction is detected, rather than just stopping the door. If the beam is not broken 560 then a signal is sent to the operator to check whether the door is still closing 570. Checking for the beam being broken 560 and querying whether or not the door is closing 570 continues until the door has ceased closing. The beam transmitter 9 and beam receiver 11 are then placed back in “sleep” state 590.

It will be appreciated that, in this embodiment, the beam transmitter 9 and beam receiver 11 conserve battery power by initially only wake the transceiver 23 for communication with the operator 1 when transitioning from a sleep state. Only if the door is closing are the infra red transmitter 17 and receiver 29 also woken. Thus, if the door is not closing, then the beam transmitter 9 and beam receiver 11 return to “sleep” mode without needing to wake up the infra red transmitter and receiver, thus conserving power. If a signal is not received by the operator 1 from both the beam transmitter 9 and beam receiver 11 querying the status of the door, then the operator determines that a problem, such as low battery, exists. The operator 1 can monitor a timer which is longer than the sleep timer of the beam transmitter and beam receiver, so that if no signal is received from either of the beam transmitter 9 or beam receiver 11, when expected, closing operations of the door can be inhibited.

An advantage of the beam transmitter and beam receiver automatically transitioning between “sleep” and “wake” states and sending an initial signal to the operator 1, is that the operator 1 does not need to synchronise timing of sending signals with “wake” state timing. Thus, the transceivers 23 of the beam transmitter 9 and beam receiver 11 can be powered down in the “sleep” state. In an embodiment where initial signals are sent be the operator 1, to cause the beam transmitter and beam receiver to wake, the transceivers 23 must either remain powered constantly to receive this signal, or wake periodically to receive this signal and synchronisation is required between waking of the transceivers and operator signal sending.

All communications between transceiver chips 23 involve transmission and reception of required data, and then an acknowledgement from beam transmitter 9 and beam receiver 11 that they have been changed from a “sleep” state to a “wake” state.

Typically, voltages of the batteries 27 may be monitored at all times for an alarm to be provided if the battery voltage level falls below a particular predetermined charge remaining level. For example, the beam transmitter and receiver may automatically transmit a battery level to the controller on transition to a “wake” state. If the battery level has fallen below a given threshold value this may be indicated to a user through the controller. For example, using a “low battery” error message on a display or lighting an indicator light on a control panel. Alternatively a “low battery” alarm condition may be transmitted to a user's remote control device and indicated to the user via a display or warning light. A self check routine may also be implemented periodically to wake the beam transmitter 9 and beam receiver 11 to test if the systems are operating correctly. If proper acknowledgement of change of state is not received then an alarm condition can be announced. An alarm condition can also be announced if there the beam is below a threshold power at the receiver or not received. For example, this may indicate a problem with dust or the alignment of the beam transmitter and beam receiver, as well as a problem with battery power.

If the door 3 is closing and the beam 13 then interrupted, motor controller 35 may be arranged to reverse the direction of travel of the door 3 so the door returns to the fully open position.

Whilst an IR beam system has been described, it should be appreciated that the beam may be any other type of beam such as a laser type beam or electromagnetic energy beam.

With the above embodiment, it can be seen that the operator 1 has electric control circuitry so that when an instruction is initiated by a user to close the door from an open position, the operator communication system will communicate with local communications systems (i.e. transceivers 23) at both the beam transmitter 9 and the beam receiver 11. The communication will be processed by respective circuits therein to change the beam transmitter and the beam receiver from “sleep” to a “wake” state, if they are not already in the “wake” state, so that the beam transmitter 9 will then transmit a beam towards the beam receiver 11 and so said beam receiver 11 will be able to process the received beam as an indication of an object not being in the path of the door. The door can then be driven to the fully closed position. If there is an interruption of a received beam it will indicate an object being in the path of the door. When interruption occurs the receiver 11 will communicate via the local communication system (transceiver 23) to the operator communication system (transceiver 23) to inhibit the operator 1 from closing the door curtain 3 by appropriate operation of the operator electric control circuitry 35.

If the transmitter of the receiver 11 are hard wired then the communication system may communicate either by radio communication (as described for the previous embodiment) or it may communicate via the hard wiring. This arrangement allows for permanent hard wiring but has the ability to place the transmitter 9 and receiver 11 in a sleep mode until required, therefore minimising power otherwise needed to operate the transmitter receiver in a continuous mode. In an embodiment the transmitter 9 and receiver 11 may be in communication with the communication system via hard wiring but are battery operated. In this embodiment the communication system may also be adapted to monitor battery power of the transmitter 9 and receiver 11 in the “sleep” state. The battery power may be monitored continuously or periodically without requiring transition of to the “wake” state, thus conserving battery power.

It should also be appreciated that the operator electric control circuitry 35 has functional components such that when the door has reached the closed position further closing will be stopped and as a consequence there will be a communication via the operator communication system to the local communication systems of both the beam transmitter 9 and the beam receiver 11 to change their states from a “wake” state to a “sleep” state. The transceiver and microcontroller in the operator may also then change state from a “wake” state to a “sleep” state.

A timer (not shown) may be utilised to provide a time delay communication for the change of state from a “wake” state to a “sleep” state. The timer may have three components: 1) to cause a change of state after closing of the door, 2) to cause a change of state after halting a movement of the door, or 3) after a set time period to cause a change of state even if the door has not been closed.

Typically, the control circuit 35 may include an override user mode to permit a user to cause the operator to override any control circuit activation to prevent closing or opening of the door. This permits the door to be closed or opened by a person physically viewing the door curtain 3 during an operation. Typically, the user manually maintains the override user mode by continually pressing a door manual operator button, such as button 43, until the door is closed or opened. In the event of non maintenance of the button being in a pressed condition the door 3 motion can be stopped.

Further, the control circuit 35 can be user activated to open the door from a closed position to allow entry or exit, and to thereafter automatically close the door curtain 3 after a suitable time. In addition, at the initiation of closing the control circuit can automatically activate the operator communications system to communicate with both the beam transmitter 9 and the beam receiver 11 to switch their states from a “sleep” state to a “wake” state to permit sensing of an object that may then be in the path of the door during closing.

The embodiments described above with reference to FIG. 1 use a manner of installation wherein the beam transmitter and beam receiver are positioned on opposite sides of the passageway. A beam projected by the beam transmitter is projected across the passageway toward the beam receiver such that the beam is received directly by the beam receiver in the absence of any obstruction.

An alternative manner of installation may be used where a projected beam is reflected towards the beam receiver. For example, the beam transmitter and beam receiver can be positioned on the same side of the passageway. A beam projected by the beam transmitter across the passageway is reflected off an object across the passageway toward the beam receiver. Depending on the type of beam the object may be a reflector such as a mirrored surface or prism. Alternatively the beam may reflect of an object such as a wall or door frame. The beam receiver may be placed in any convenient position to receive a reflected beam after its projections across the passageway and need not be located on the same side of the passageway as the beam transmitter.

The operation of the door operator is substantially identical in the reflective installation to the operation as described above. The exception for the reflective installation is that the beam receiver can be adapted to distinguish between a beam reflected from the object across the passageway and a beam reflected from an object present in the passageway. For example, the beam receiver may take into consideration a time delay or Doppler shift in the received beam to detect a beam reflected from an obstruction. This can require some additional processing at the beam receiver. An obstruction may also inhibit reception of the beam, thus enabling detection of an obstruction in the passageway as described above.

A reflective installation may be useful where there is insufficient space on one side of the passageway to position a beam receiver or beam transmitter case. The beam receiver and beam transmitter may be placed adjacent to each other on one side of the passageway or be separated from each other on one side of the passageway. An advantage of separating the beam transmitter and beam receiver in a reflective embodiment is two beams having different paths are projected across the passageway. This provides a greater field for detection of an obstruction.

In some embodiments designed only for use in a reflective installation the beam receiver and beam transmitter may be housed in the same case. In this embodiment some components of the beam transmitter and beam receiver may be shared, for example batteries, microprocessors, transceivers etc may be shared. All alternative arrangements are contemplated within the scope of the present invention.

It should be appreciated that beam protection system disclosed herein can be configured for use as a retro-fit to existing door operators 1.

The arrangement above may be incorporated with other known operator unit technology such as disclosed in our Australian Patent Application Nos. 2009201063, 2009200327, 2009203038 and 2010200132. The subject matter of the above patent applications is incorporated herein by reference.

Modifications may be made by persons skilled in the art without departing from the ambit of the invention the nature of which is to be determined from the foregoing description.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A door operator with an obstruction beam protection system for sensing an object in the path of the door during closing of the door by the operator and for inhibiting operation for closing of the door,
said beam protection system comprising a beam transmitter and beam receiver for positioning proximate to a passageway to be closed by the door, so as, when in use, to project a beam from the beam transmitter across the passageway to be receivable by the beam receiver, the beam transmitter and the beam receiver being provided with a local communication system for communication with an operator communication system associated with the operator,
the beam transmitter and the beam receiver both adapted to operate in a low power “sleep” state and a “wake” state, so that in the “wake” state the beam transmitter will transmit a beam across the passageway to be receivable by said beam receiver and so said beam receiver will be able to process a received beam as an indication of an object not being in the path of the door, and the absence or interruption of a received beam as an indication of an object being in the path of the door and in this later condition of absence or interruption, communicate via the local communication system to the operator communication system to inhibit said operator from closing said door by appropriate operation of the operator electric control circuitry.

2. A door operator as claimed in claim 1 wherein the operator has electric control circuitry configure to in response to an instruction initiated by a user being provided to close the door from an open position said operator communication system will communicate with the local communication system so the communication will be processed by respective circuitry in the beam transmitter and the beam receiver to change the beam transmitter and the beam receiver from a “sleep” state to a “wake” state, if they are not already in the “wake” state.

3. A door operator as claimed in claim 1 wherein at least one of the beam transmitter and the beam receiver is adapted to periodically change from a “sleep” state to a “wake” state and communication with the operator communication system to determine whether the operator is instructed to close the door from an open position to a closed position and if the operator is instructed to close the door the beam transmitter will transmit the beam receivable by the beam receiver.

4. A door operator as claimed in any one of the preceding claims wherein the beam transmitter and beam receiver are further configured to identify fault conditions for any one or both of the beam transmitter an beam receiver and when a fault condition is detected communicate via the local communication system to indicate the fault condition to the operator whereby the operator can inhibit operating the door.

5. A door operator as claimed in claim 4 wherein fault conditions include any one or more of: misalignment of the beam transmitted between the beam transmitter and beam receiver; damage to the beam transmitter; damage to the beam receiver; fault condition in the beam transmitter; and fault condition in the beam receiver.

6. A door operator as claimed in any one of the preceding claims, wherein said operator electric control circuitry has components to sense when the door has reached a closed position and to stop further closing and as a consequence to also forward a communication via said operator communication system to the local communication systems of both said beam transmitter and said beam receiver to change their states from a “wake” state to a “sleep” state.

7. A door operator as claimed in any one of the preceding claims, wherein said operator electric control circuitry has a timer to be activated on receipt of a communication from said beam receiver local communication system to initiate an inhibited operation of said door, so that after a suitable time, there can be a communication via the operator communication system to the local communication system of the beam transmitter and the beam receiver to change their states from a “wake” state to a “sleep” state.

8. A door operator as claimed in any one of the preceding claims, wherein the local communication system in both of the beam transmitter and the beam receiver are configured to communicate with the operator communication system upon changing state from a “sleep” state to a “wake” state to confirm they have changed state to a “wake” state, and wherein the control circuit is configured in the absence of a communication establishing both the beam transmitter and the beam receiver are in a “wake” state, to inhibit operation of the operator.

9. A door operator as claimed in any one of the preceding claims, wherein the beam transmitter and the beam receiver are both stand alone devices and are wireless coupled with respect to said control circuit.

10. A door operator as claimed in claim 9, wherein both the beam transmitter and the beam receiver are each battery powered by a respective local battery.

11. A door operator as claimed in claim 10, wherein the beam transmitter and the beam receiver each communicate local battery status to the operator communication system, and wherein the control circuit is configured to alert a user to low battery status.

12. A door operator as claimed in claim 10, where both the beam transmitter and the beam receiver each comprise a battery recharging component.

13. A door operator as claimed in claim 12, wherein the battery recharging component is a solar cell recharge device.

14. A door operator as claimed in any one of the preceding claims, wherein said control circuit comprises an override user mode to permit a user to cause the operator to override any control circuit activation to prevent closing of the door.

15. A door operator as claimed in claim 14, wherein said override user mode requires a user to manually maintain the override user mode until the door has closed, and in the event of non maintenance to stop closing.

16. A door operator as claimed in any one of the preceding claims, wherein said control circuit can be user activated to open the door from a closed position, to allow entry or exit, and to thereafter automatically close the door after a suitable time, and at the initiation of closing to automatically activate said operator communication system to communicate with both said beam transmitter and said beam receiver to switch their states from a “sleep” state to a “wake” state to permit sensing of an object that may then be in the path of the door during closing.

17. A door operator as claimed in any one of the preceding claims, wherein the beam transmitter and beam receiver are positioned on opposite sides of the passageway such that a beam is projected by the beam transmitter across the passageway towards the beam receiver to be receivable by the beam receiver.

18. A door operator as claimed in any one of claims 1 to 16, wherein the beam transmitter and beam receiver are positioned such that a beam projected by the beam transmitter across the passageway is reflected off an object across the passageway toward the beam receiver to be receivable by the beam receiver.

19. A door operator as claimed in any one of the preceding claims, wherein both the beam transmitter and the beam receiver are I.R. beam devices.

20. A door operator as claimed in any one of claims 1 to 18, wherein both the beam transmitter and the beam receiver are laser devices.

21. An obstruction beam protection system configured for operation with a door operator to sense an object in the path of the door during closing of the door by the operator and signalling the door operator to inhibit operation for closing of the door, the beam protection system comprising
a beam transmitter and beam receiver for positioning proximate to a passageway to be closed by the door operated by the operator, so as, when in use, to project a beam from the beam transmitter across the passageway to be receivable by the beam receiver, the beam transmitter and the beam receiver being provided with a local communication system for communication with an operator communication system associated with the operator,
the beam transmitter and the beam receiver both adapted to operate in a low power “sleep” state and a “wake” state, so that in the “wake” state the beam transmitter will transmit a beam across the passageway to be receivable by said beam receiver and so said beam receiver will be able to process a received beam as an indication of an object not being in the path of the door, and the absence or interruption of a received beam as an indication of an object being in the path of the door and in this later condition of absence or interruption, communicate via the local communication system to the operator communication system to inhibit said operator from closing said door by appropriate operation of the operator electric control circuitry.

22. A beam protection system as claimed in claim 21 wherein the beam transmitter and beam receiver receive a signal from the operator, in response to an instruction initiated by a user being provided to close the door from an open position, via the local communication system to be processed by respective circuitry in the beam transmitter and the beam receiver to change the beam transmitter and the beam receiver from a “sleep” state to a “wake” state, if they are not already in the “wake” state.

23. A beam protection system as claimed in claim 21 wherein at least one of the beam transmitter and the beam receiver is adapted to periodically change from a “sleep” state to a “wake” state and communication with the operator communication system to determine whether the operator is instructed to close the door from an open position to a closed position and if the operator is instructed to close the door the beam transmitter will transmit the beam receivable by the beam receiver.

24. A door operator as claimed in any one of claims 21 to 23 wherein the beam transmitter and beam receiver are further configured to identify fault conditions for any one or both of the beam transmitter an beam receiver and when a fault condition is detected communicate via the local communication system to indicate the fault condition to the operator whereby the operator can inhibit operating the door.
